(19) United States
(12) Patent Application Publication
(10) Pub. No.: US 2006/0222216 A1
(43) Pub. Date: Oct. 5, 2006

(54) Electrical apparatus and method of communication between an apparatus and a user

(75) Inventors: Eric Thelen, Aachen (DE); Matthew David Harris, Aachen (DE); Vasanth Philomin, Stolberg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, 5621 BA Eindhoven (NL)

(21) Appl. No.: 10/552,814

(22) PCT Filed: Apr. 5, 2004
(86) PCT No.: PCT/IB04/01066

§ 371 Date: Oct. 11, 2005

(30) Foreign Application Priority Data
Apr. 14, 2003 (EP) 03101003.6

(51) Int. Cl. G06F 3/00

(52) U.S. Cl. 382/118; 345/158; 715/700

(57) ABSTRACT

An electric apparatus and a method of communication between an apparatus and a user are described. The apparatus comprises sensor means, for example, a camera (18) for detecting objects (34, 36) in its proximity. The position of objects (34, 36) is stored in a memory (M). A directional pointing unit (20), for example, in the form of a mechanical pointing element or with a light source for generating a concentrated light beam (40) can be directed onto objects in the proximity of the apparatus. In a dialog, the corresponding object can thus be pointed out to a human user.

It is known that there is a multitude of possibilities for the communication between a user and an electric apparatus. For the input into the apparatus, these possibilities comprise mechanical or electrical input means such as keys or touch screens, as well as optical (e.g. image sensors) or acoustical input means (microphones with their corresponding signal processing, e.g. speech recognition). For the output of an apparatus to the user, several possibilities are also known, such as particularly optical (LEDs, display screens, etc.) and acoustical indications. The acoustical indications may not only comprise simple reference tones but also, for example, speech synthesis. By combining speech recognition and speech synthesis, a natural speech dialog for controlling electric apparatuses can be used.

U.S. Pat. No. 6,118,888 describes a control device and a method of controlling an electric apparatus, e.g. a computer or a consumer electronics apparatus. For the control of the apparatus, the user has a number of input possibilities such as mechanical input possibilities like keyboards or a mouse, as well as speech recognition. Moreover, the control device is provided with a camera with which the user's gestures and mimicry can be picked up and processed as further input signals. The communication with the user is realized in the form of a dialog in which the system also has the disposal of a number of modes of transmitting information to the user. These modes are speech synthesis and speech output. Particularly, these modes also comprise an anthropomorphic representation, e.g. a representation of a human being, a human face or an animal. This representation is shown as a computer graphic image on a display screen.

The input and output means hitherto known are, however, cumbersome in some applications, for example, when the electric apparatus, in a dialog with the user, should indicate positions or objects in its proximity.

It is therefore an object of the invention to provide an apparatus and a method of communication between an apparatus and a user, with which a simple and efficient communication is possible, particularly when indicating objects in its proximity.

This object is solved by an apparatus as defined in claim 1 and a method as defined in claim 10. Dependent claims are defined in advantageous embodiments of the invention.

The invention is based on the recognition that the simulation of human communication means is also advantageous for the communication between an apparatus and a human user. Such a communication means is pointing. The apparatus according to the invention therefore comprises a directional pointing unit which can be directed onto objects in its proximity.

For a useful application of pointing, the apparatus requires information about its proximity. According to the invention, sensor means for detecting objects are provided. In this way, the apparatus can detect its proximity itself and localize objects. Within the interaction with the user, the pointing unit can be directed accordingly so as to point at these objects.

In the apparatus, the position of objects can be directly transmitted from the sensor means to the pointing unit. This is, for example, useful when tracking, i.e. following a moving object is desired. However, the apparatus preferably comprises at least one memory for storing the position of objects.

The pointing unit can be realized in different ways. On the one hand, it is possible to use a mechanical pointing element having e.g. an elongated shape and being mechanically movable. The mechanical movement preferably comprises a swiveling movement of the mechanical pointing element about at least one, preferably two axes perpendicular to the pointing direction. The pointing element is then swiveled by appropriate drive means in such a way that it is directed onto objects in its proximity. Similarly as when pointing (with a finger) in human communication, it is thus possible for the apparatus to indicate objects.

On the other hand, a pointing unit may also comprise a light source. For the purpose of pointing, a concentrated light beam is generated, for example, by using a laser or an appropriate optical system or a diaphragm. The light beam can be directed onto objects in the proximity of the apparatus by using appropriate means so that these objects are illuminated and thus indicated in the process of communication between the apparatus and a human user. For directing the light beam, the light source may be arranged to be mechanically movable. Alternatively, the light generated by the light source may also be deflected into the desired direction by one or more mechanically movable mirrors.

The sensor means according to the invention for detecting objects in the proximity of the apparatus may be formed, for example, as optical sensor means, particularly a camera. When suitably processing images, it is possible to recognize objects within the detection range and to determine their relative position with respect to the apparatus. The position of objects can then be suitably stored so that, when it will be necessary to indicate an object in the process of communication with the user, the pointing unit can be directed onto this object.

In accordance with a further embodiment of the invention, the apparatus comprises a mechanically movable personification element. This is a part of the apparatus which serves as the personification of a dialog partner for the user. The concrete implementation of such a personification element may be very different. For example, it may be a part of a housing which is motor-movable with respect to a stationary housing of an electric apparatus. It is essential that the personification element has a front side which can be recognized as such by the user. If this front side faces the user, he is thereby given the impression that the apparatus is “attentive”, i.e. can receive, for example, speech commands.

For this purpose, the apparatus comprises means for determining the position of a user. These means are preferably the same sensor means that are used for detecting objects in the proximity of the apparatus. Motion means of the personification element are controlled in such a way that the front side of the personification element is directed towards the user's position. The user thus constantly has the impression that the apparatus is prepared to “listen” to him.

The personification element may be, for example, an anthropomorphic representation. This may be the representation of a human being or an animal, but also a fantasy figure. The representation is preferably an imitation of a human face. It may be a realistic or only a symbolic representation in which, for example, only the contours such as eyes, nose and mouth are shown.

The pointing unit is preferably arranged on the personification element. The mechanical movability of the personification element can be utilized in such a way that the directional possibilities of the pointing unit are completely or partly ensured. For example, if the personification element is rotatable about a perpendicular axis, a pointing unit arranged on the personification element can also be moved, due to this rotation, and directed onto objects. If necessary, the pointing unit may have additional directional means (drives, mirrors).

It is preferred that the device comprises means for inputting and outputting speech signals. Speech input is understood to mean the pick-up of acoustic signals, on the one hand, and their processing by means of speech recognition, on the other hand. Speech output comprises speech synthesis and output by means of, for example, a loudspeaker. By using speech input and output means, a complete dialog control of the apparatus may be realized. Alternatively, for entertaining the user, dialogs can also be held with him.

An embodiment of the apparatus will hereinafter be elucidated with reference to drawings. In the drawings:

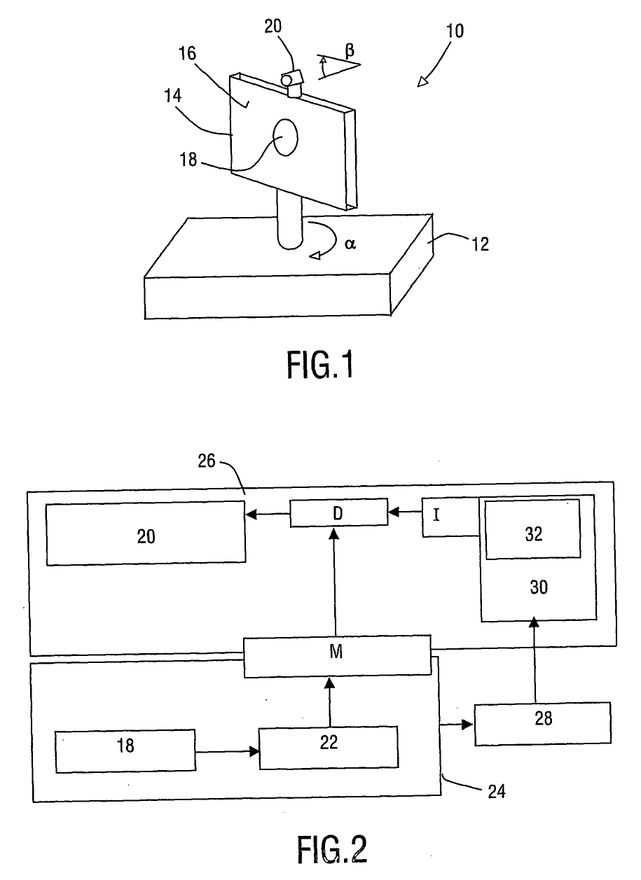

FIG. 1 shows an embodiment of an apparatus;

FIG. 2 is a symbolic representation of functional units of the apparatus;

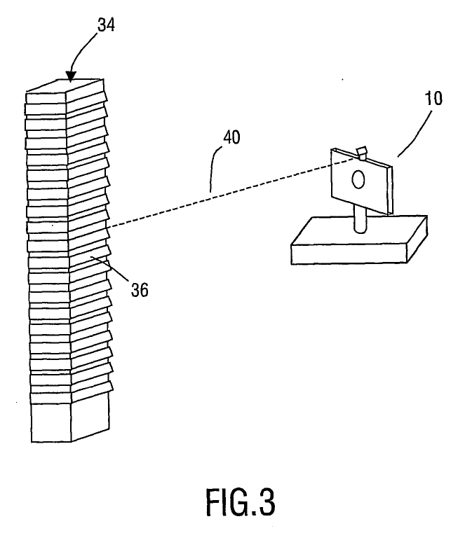

FIG. 3 shows the apparatus of FIG. 1 with an object in its proximity.

FIG. 1 shows an electric apparatus 10. The apparatus 10 has a base 12 with a personification element 14 which is 360° swivable with respect to the base 12 about a perpendicular axis. The personification element 14 is flat and has a front side 16.

The apparatus 10 has a dialog system for receiving input information from a human user and for transmitting output information to the user. Dependent on the implementation of the apparatus 10, this dialog may be used itself for controlling the apparatus 10, or the apparatus 10 operates as its own control unit for controlling other apparatuses connected thereto. For example, the apparatus 10 may be a consumer electronics apparatus, for example, an audio or video player, or such consumer electronics apparatuses are controlled by the apparatus 10. Finally, it is also possible that the dialogs held with the apparatus 10 do not have the control of apparatus functions as their priority target, but may be used for entertaining the user.

The apparatus 10 may detect its proximity by means of sensors. A camera 18 is arranged on the personification element 14. The camera 18 detects an image within its range in front of the front side 16 of the personification element 14.

By means of the camera 18, the apparatus 10 can detect and recognize objects and persons in its proximity. The position of a human user is thus detected. The motor drive (not shown) of the personification element 14 is controlled with respect to its adjusting angle α in such a way that the front side 16 of the personification element 14 is directed towards the user.

The apparatus 10 can communicate with a human user. Via microphones (not shown) it receives speech commands from a user. The speech commands are recognized by means of a speech recognition system. Additionally, the apparatus includes a speech synthesis unit (not shown) with which speech messages to the user can be generated and produced via loudspeakers (not shown). In this way, interaction with the user can take place in the form of a natural dialog.

Furthermore, a pointing unit 20 is arranged on the personification element 14. In the embodiment shown, the pointing unit 20 is a mechanically movable light source in the form of a laser diode with a corresponding optical system for generating a concentrated, visible light beam.

The pointing unit 20 is of the directional type. By suitable motor drive (not shown), it can be swiveled at a height angle β with respect to the personification element 14. By combining the swiveling of the personification element 14 about an angle α and an adjustment of a suitable height angle β, the light beam from the pointing unit 20 can be directed onto objects in the proximity of the apparatus.

The apparatus 10 is controlled via a central unit in which an operating program is performed. The operating program comprises different modules for different functionalities.

As described above, the apparatus 10 can perform a natural dialog with a user. The corresponding functionality is realized in the form of software modules. The required modules of speech recognition, speech synthesis and dialog control are known to those skilled in the art and will therefore not be described in detail. Fundamentals of speech recognition and also information about speech synthesis and dialog system structures are described in, for example, “Fundamentals of Speech Recognition” by Lawrence Rabiner, Biing-Hwang Juang, Prentice Hall, 1993 (ISBN 0-13-015157-2) and in “Statistical Methods for Speech Recognition” by Frederick Jelinek, MIT Press, 1997 (ISBN 0-262-10066-5) and “Automatische Spracherkennung” by E. G. Schukat-Talamazzini, Vieweg, 1995 (ISBN 3-528-05492-1), as well as in the documents mentioned as references in these books. A survey is also provided in the article “The thoughtful elephant: Strategies for spoken dialog systems” by Bernd Souvignier, Andreas Kellner, Bernhard Rueber, Hauke Schramm and Frank Seide in IEEE Transactions on Speech and Audio Processing, 8(1):51-62, January 2000.

Within the scope of the dialog with the user, the apparatus 10 is capable of indicating objects in its proximity by pointing at them. To this end, the pointing unit 20 is aligned accordingly and a light beam is directed onto the relevant object.

The software structure for controlling the pointing unit will now be elucidated. The lower part of FIG. 2 shows an input sub-system 24 of the apparatus 10. In this Figure, the sensor unit, i.e. the camera 18 of the apparatus 10 is shown as a general block. The signal picked up by the camera is processed by a software module 22 for the purpose of proximity analysis. Information about objects in the proximity of the apparatus 10 is extracted from the image picked up by the camera 18. Corresponding image processing algorithms for separating and recognizing objects are known to those skilled in the art.

The information about objects that have been recognized and their relative position with respect to the apparatus 10, expressed in this example by the angle of rotation α and the height angle β, are stored in a memory M.

The upper part of FIG. 2 shows an output sub-system 26 of the apparatus 10. The output sub-system 26 is controlled by a dialog module 28 in such a way that it provides given output information. An output planning module 30 takes over the planning of the output information and checks whether the output information is to be given by using the pointing unit 20. A partial module 32 thereof determines which object in the proximity of the apparatus 10 should be pointed at.

A driver D for the pointing unit is controlled via an interface module I. The driver D is informed which object must be pointed at. The driver module D queries the memory M for the position to be controlled and controls the pointing unit 20 accordingly. For pointing at the object, the drives (not shown) are controlled for rotating the personification element 14 at the fixed angle α and for directing the pointing unit 20 at the relevant height angle β.

An example of a situation is shown in FIG. 3. A CD rack 34 with a number of CDs 36 is present in the proximity of the apparatus 10. The camera 18 on the front side 16 of the personification element 14 detects the image of the CD rack 34. By suitable image processing, the individual CDs 36 that are present in the rack 34 can be recognized. In the case of a suitable optical resolution, it is possible to read the titles and performers. This information, together with the information about the position of the individual CD (i.e. the angle of rotation α of the rack 34 and the height angle β of the relevant CD with respect to the apparatus 10) is stored in a memory.

In a dialog held with the user, the apparatus 10 should make a proposal to the user about the CD he can listen to. The dialog control module 28 is programmed accordingly, so that, via the speech synthesis, it asks the user questions about a preferred music genre and assigns his answers via the speech recognition. After a suitable selection of the CDs 36 in the rack 34 is made on the basis of the information thus gathered, the output sub-system 2 is put into operation. This sub-system controls the pointing unit 20 accordingly. A light beam 40 emitted by the pointing unit is thus directed onto the selected CD 36. Simultaneously, the user is informed via the speech output information that this is the recommendation made by the apparatus.

The above-described application of an apparatus 10 for selecting an appropriate CD should only be understood to be an example of using a pointing unit. In another embodiment (not shown), the apparatus 10 is a security system, e.g. connected to the control unit of an alarm installation. In this case, the pointing unit is used to draw the user's attention to places in a room which might lead to security problems, for example, an open window.

A multitude of other applications is feasible for an apparatus which can point at objects in its proximity by means of a pointing unit 20. Such an apparatus may not only be a stationary apparatus but also a mobile apparatus, for example, a robot.

In a further embodiment, the apparatus 10 can track the movement of an object in its proximity by means of the camera 18. The personification element and the pointing unit 20 are controlled in such a way that the light beam 40 remains directed onto the moving object. In this case, it is possible that the object co-ordinates are not buffered in the memory M but that the driver D for the pointing unit is directly controlled by the software module 22 for the purpose of proximity analysis.

1. An electric apparatus comprising:
sensor means (18) for detecting objects (34, 36) in the proximity of the apparatus (10), and
a directional pointing unit (20) which can be directed onto objects (34, 36) in the proximity of the apparatus (10).

2. An apparatus as claimed in claim 1, comprising:
at least one memory (M) for storing the position (α, β) of objects (34, 36).

3. An apparatus as claimed in claim 1, wherein
the pointing unit comprises a mechanical pointing element which is mechanically movable in such a way that it can be directed onto objects in the proximity of the apparatus.

4. An apparatus as claimed in claim 1, wherein
the pointing unit (20) comprises a light source for generating a concentrated light beam (40), and
means for directing the light beam (40) onto objects (34, 36) in the proximity of the apparatus (10).

5. An apparatus as claimed in claim 4, wherein
the light source is mechanically movable.

6. An apparatus as claimed in claim 4, wherein
means for directing the light beam (40) comprise one or more mechanically movable mirrors.

7. An apparatus as claimed in claim 1, comprising
a personification element (14) having a front side (16),
motion means for mechanically moving the personification element (14),
means for determining the position of a user, and
control means which are constituted in such a way that they control the motion means in such a way that the front side (16) of the personification element (14) is directed towards the user's position.

8. An apparatus as claimed in claim 7, wherein the pointing unit (20) is arranged on the personification element (14).

9. An apparatus as claimed in claim 1, comprising
means for speech recognition and speech output.

10. A method of communication between an apparatus (10) and a user, wherein
the apparatus (10) detects objects (34, 36) in its proximity by way of sensor means (18), and
stores the position of objects (34, 36) in a memory (M), and aligns a directional pointing unit (10) with one of the objects (36).
